(19) United States
(12) Patent Application Publication
(10) Pub. No.: US 2007/0157499 A1
(43) Pub. Date: Jul. 12, 2007

(54) Thermoformed display tag holder

(76) Inventors: Nicholas Kalouris, Addison, IL (US); Poulokefalos Dmitris, South Barrington, IL (US); Vangelis Economou, Wilmette, IL (US)

Correspondence Address: Vangelis Economou, 601 Hunter Road, Wilmette, IL, 60091, US

(21) Appl. No.: 11/327,231

(22) Filed: Jan. 7, 2006

(51) Int. Cl. G09F 3/00

(52) U.S. Cl. 40/642.01

(57) ABSTRACT

A display tag holder that has a mounting portion, an intermediate portion, and a display portion, and a method of thermoforming such a display tag holder. The mounting portion mounts to a merchandise display hook with the intermediate portion extending above the hook so as to extend downwards and forwards of the forward tip of the hook. The mounting portion has at least two restrictions for mounting on attachment points of the merchandise display hook to a base mount, the restrictions providing an interference fit between the hook and the mounting portion, and may include a raised portion. These features help to prevent the holder from falling off the hook or hanging under the hook in the event that a customer accidentally bumps or brushes against the holder. The display portion includes a parallel pair of grooves for retaining a display tag, and which can extend either vertically or horizontally.

### BACKGROUND OF THE INVENTION

1. Field of the Invention

The invention relates generally to a display tag holder for merchandise suspended from a horizontally extending support hook, or the like. More particularly, the present invention relates to a thermoformed display tag holder that is easily attached to and removed from a product support hook without being subject to inadvertent removal and which is capable of retaining its orientation relative to the hook.

2. Background Art

Display tag holders are well known in the merchandising field. They are conventionally formed from a urethane or polyvinyl plastic sheet that is preferably die cut and thermoformed into the appropriate shape. The display tag holders normally display product information forwardly of items that are suspended from a hook extending horizontally from a vertical pegboard, and the hook is disposed immediately below the display tag holder. For example, commonly owned U.S. Pat. No. 6,694,654 to Poulokefalos et al. discloses a display tag holder that is adequate to provide the desired benefits for some types of hooks, it is not sufficient to be utilizable with hook types having a square type of attachment to the pegboard. Nevertheless, some of the improvements described in U.S. Pat. No. 6,694,654 are also utilizable in this application, and the disclosure thereof is incorporated by reference as if fully set forth herein.

A conventional display tag holder includes a mounting portion arranged to be temporarily deformed while being attached to and removed from a connection to an associated hook at a location adjacent to the pegboard, an intermediate portion which projects forwardly from the pegboard and extends over the support hook and the merchandise supported thereon, and a display portion which bends downwardly from the distal end of the intermediate portion in front of the hook so as to display the desired product information.

Label holders are occasionally prone to lateral bending or flexing of the holder body along its intermediate portion as a result of customers contacting the holder. This results in the display portion of the holder being positioned beside the suspended merchandise and not in front of it. Thus, the label holder may be displayed not in direct view of customers. Such bending or flexing can occur when a customer who is removing a merchandise item from an adjacent hook accidentally brushes against the holder. A number of improvements have been proposed in aforementioned commonly owned U.S. Pat. No. 6,694,654 to provide benefits in reducing the bending or flexing of the tag holder after it has been installed and simultaneously provides sufficient flexibility in the holder to accommodate twisting, so as to stabilize the intermediate portion of the label holder. Also, the increased stiffness and rigidity of the holder helps to prevent the holder from unintentionally falling off the hook and out of view when a customer accidentally bumps into or brushes against the holder.

Additional features relate to the attachment of the tag holder to the pegboard or other attachment means, so that he distal or rear end of the tag holder can be securely attached, and different types of hook attachments to the pegboard require adaptation of the tag holder to the type of hook and attachment structure. However, other types of attachments are used in merchandising displays, for example, used in attaching various display fixtures to slot walls, wire grid walls, hang bars and many other types of display fixtures. Thus, a need exists for attachment of tag holders to different types of hooks and hook mounting and attachment structures.

Another difficulty in conventional display tag holders is that, at present, the tags displaying the product information, for example, price, are affixed to the forward or proximal end of the tag holder by glue or adhesive. Thus, in order to change the indicia or information displayed on the display portion of the display tag holder, the store or entity that is using the display tag holders must either paste a new or different tag with the desired information over the one that had been previously pasted on. This may and often does result in tags being displayed in an unsightly or skewed manner. Another alternative is to replace the display tag holder with a new display tag holder having a new individual price tag over that hook. The latter method, of course leads to waste and additional expense in having to replace the display tag holder and also in disposing of the used display tag holders in an environmentally friendly way. The need to detach and correctly reattach a new display tag holder to a hook attachment means also requires time and effort on the part of the person who is maintaining he display tag holders.

Display tag holders that provide for changing the price tag are known, but not in the context of a display tag holder as described in U.S. Pat. No. 6,694,654. For example, U.S. Pat. No. 5,375,803 discloses securing planar panels to a price display holder, securing several sheets of material together or in securing a dispenser to the front edge of a shelf. These devices operate by locking the two halves of a holder that is bent over to be folded and thus to maintain the price display in position. Such devices are not associated directly with displays having a hook for attachment of the goods being sold, nor does the tag holder have a means for easily changing the price tag information without requiring elaborate manipulation of the user. Similarly, U.S. Des. Pat. Nos. D440,606 and D425,939 show the use of sign holders in which a tag or sign can be easily inserted or removed, U.S. Pat. No. 5,470,138 teaches a foldable tag holder that has a space for displaying a sign, and a means of locking the two halves of the folded holder to maintain the sign in position. U.S. Pat. No. 6,082,687 provides a flag or tag display holder, but none of these types of holders can be made by using an inexpensive process, such as the one used in the present invention. To make these holders, a “three dimensional” construction is required that must be mad by extrusion or mold forming of the plastic, and these articles cannot be made by standard thermoform methods.

U.S. Pat. No. 6,553,702 discloses an extruded holder for an electronic price label, in which an electronic device is held adjacent the merchandise, and the electronic price label indicates the information in an electronic format and may provide for other means for imparting in formation, for example, issuing a receipt of printed matter or the like to be viewed in association with the price and other information displayed by the associated electronic price label. This method requires a significant cost of operation and an initial investment in the electronic displays and electronic price label systems that may be financially prohibitive to some retail users.

All of these display tag holders are not able to achieve the purpose for which they were intended, either because the connection to the hook is not appropriate for the specific hook construction, or there is no provision made for the easy replacement of the price tag display without succumbing to one or more of the above described problems.

One method of reducing the costs of display tag holders is to produce them by known plastic manufacturing processes, for example, by thermoforming. Thermoforming of plastic articles has been proposed as providing the benefits of shaping a plastic preform to achieve a desired shape while reducing manufacturing costs. For example, U.S. Pat. No. 5,795,535 teaches a method of thermoforming plastic articles, but the articles that have been formed by such processes have been formed in “two dimensional” format that significantly reduces the ability to accommodate the desired uses for the articles. For example, thermoformed display tag holders to date have needed to be folded or otherwise bent in order to retain planar objects, for example, price tags, without external manipulation or adhesives, is desirable. A “wraparound” construction that has one or more cantilevered protrusions or lips that can retain a rigid or semi-rigid configurations to retain a sign or price tag formed by thermoforming processes is ideal. Accordingly, it is considered desirable to develop a new and improved label holder which would overcome these and other problems while providing better and more flexible and durable display tag holders capable of accommodating inadvertent twists and deformations. What is thus needed is a display tag holder that can be made inexpensively, but is capable of permitting the user to easily change the tag information, especially when it is in the form of a planar tag, or rectangular sign having predetermined dimensions. An arrangement that can be used with known thermoforming processes is particularly desirable, in that providing protrusions and indentations so as to achieve a “three-dimensional” configuration including cantilevered forms into which the price tag can be inserted and securely retained is ideally suited to the merchandising field.

### SUMMARY OF THE INVENTION

A display tag holder for use with a forwardly extending merchandise display hook hanging from a wall removably attaches to the hook structure and is further held in place 30 by also fitting and attaching around the base of the hook. The display tag holder provides for mounting with and around base of a forwardly extending merchandise display hook, the display tag holder comprising a display portion, a mounting portion oppositely disposed along a longitudinal line of the display tag holder from the display portion, and an intermediate portion extending between the display portion and the mounting portion.

The hook structure includes a base and a hook, the base being attached to a wall or pegboard at a rear end permitting the hook to extend forwardly from the hook base. The tag holder extends forwardly from the hook structure and is disposed above the hook. The display portion preferably extends downwardly from a proximate end of he intermediate portion in front of a distal forward end of the hook to provide for a space to display merchandise information, such as price and product information for products that are hung onto the hook. The tag holder display portion has several cantilevered projections at the edges that provide an open groove configuration that is capable of holding the display tag in a tongue-in-groove manner.

In other embodiments, the inventive display tag holder may comprise a thermoformed mounting portion, as described above, or another mounting configuration, and one of several tag display portions including a mechanism to hold the display tag in place so that it is visible to a customer immediately in front of a product display including products that are hung on the hook and available for purchase.

### BRIEF DESCRIPTION OF THE DRAWINGS

FIG. 1 is a plan view of a first embodiment of the display tag holder according to the present invention, shown without folds;

FIG. 2 is an enlarged perspective view of the mounting portion of the display tag holder according to the invention shown in FIG. 1;

FIG. 3 illustrates in a perspective view the display tag holder shown in FIG. 1 having the two ends folded as in use in a merchandising display;

FIG. 4 is an enlarged perspective detail view of the display tag holder forward end showing the configuration of the cantilevered display tag securing member according to the present invention;

FIG. 5 illustrates in a perspective view the display tag holder shown in FIGS. 1,3 and 4 having the two ends folded in a merchandising display in association with a merchandise display hook hanging on a wall;

FIG. 6 is a cross-sectional side view taken approximately along the line VI-VI of FIG. 5;

FIG. 7 is a partial perspective view of the front display portion of another embodiment of the display tag holder according to the present invention;

FIG. 8 is a partial perspective view of the front display portion of another embodiment of the display tag holder according to the present invention;

FIG. 9 is a partial perspective view of the front display portion of yet another embodiment of the display tag holder according to the present invention;

FIG. 10 is a partial perspective view of the front display portion of yet another embodiment of the display tag holder according to the present invention;

FIG. 11 is a partial perspective view of the front display portion of yet another embodiment of the display tag holder according to the present invention;

FIG. 12 is a partial perspective view of the front display portion of still yet another embodiment of the display tag holder according to the present invention;

FIG. 13 is a partial perspective view of the front display portion of another embodiment of the display tag holder according to the present invention;

FIG. 14 is a partial perspective view of the front display portion of yet another embodiment of the display tag holder according to the present invention;

FIG. 15 illustrates in a partial plan view the display tag holder shown in FIG. 14 in a horizontal flat condition before the front display portion has been bent over for use; and

FIG. 16 is a cross-sectional side view taken approximately along the line 16-16 of the tag front display portion shown in FIG. 15.

### DETAILED DESCRIPTION OF THE PREFERRED EMBODIMENTS

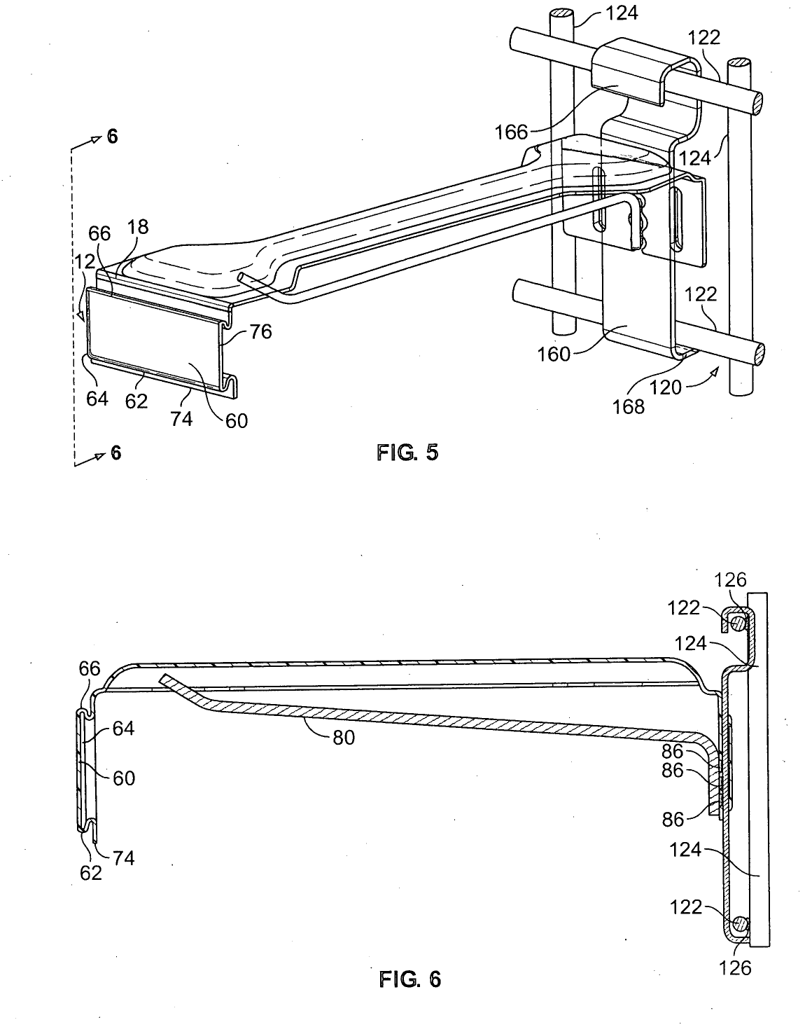

A first preferred embodiment of the display tag holder 10 is shown in FIGS. 1-4, and is also illustrated in FIGS. 5 and 6. The embodiment of the display tag holder 10 is also shown in FIGS. 5 and 6, with the addition of the illustrated use with a hook according to the type used with the mounting portion of the display tag holder of FIG. 1. The identical elements illustrated in each of these figures will be identified by identical numerals. Moreover, many of the elements that are described in aforementioned commonly owned. U.S. Pat. No. 6,694,654 to Poulokefalos et al. may also be used with the present invention, and the detailed description of like parts and functions of that patent will be set forth herein only if it relates to the present invention.

Referring now to FIGS. 1 through 4, the display tag holder 10 is shown in a manufactured state, soon after it has come off of the thermoform device by which the inventive tag holders are made. Thus, the preferred embodiment of display tag holders 10 is in the manufactured state prior to delivery to the ultimate merchandiser or user of the tag holders. In this condition, the tag holder is shown before the user has folded the ends at fold lines 18, 20 to attach the mounting portion 14 to a hook (FIG. 5).

The description of the portions of the display tag holder 10 is more completely understood when considered with reference to the description of the use environment, that is, when the display tag holder 10 is used in conjunction with the hook 60 and wall or wire mesh structure 120 by mounting thereto, as is shown in FIGS. 5 and 6. However, the following description is limited to the display tag holder 10 before describing the use environment, i.e., the attachment to the pegboard wall or wire structure of the hook, so that the inventive production device and processes may be more completely described. The following description relates to the elements of the completely manufactured preferred embodiments of tag holders 10. Where necessary, use of the tag holders 10, 110 will be described with reference to the use environment, as shown in FIGS. 5-6, to provide a better understanding of the invention.

The thermoforming process of producing the inventive tag holders provides a distinct advantage and is a significant feature of this invention, as this process permits the ability to manufacture the tag holders 10 at an increased rate, while maintaining the quality of the finished products, all the while reducing the costs of the production process. Thermoforming of plastic sheets is a well-known process, and has been used extensively in the plastic article production field. The tag holder 10 is typically manufactured from a sheet of plastic and is not injection molded. Preferably, the tag holder 10 is thermoformed by a vacuum process by which the plastic sheet is first heated until it achieves a very plastic, almost fluid state. It is easy to form it in such a fluid state, and by using known vacuum processes, the plastic sheet is then formed to produce one, or preferably more, up to about sixteen tag holders 10 simultaneously on a thermoformed platen (not shown) which is cooled by, for example, a continuous cooling water stream flowing through piping in the thermoforming platen.

Quick cooling of the sheet including the formed tag holders 10 hardens the tag holder rough forms into a final stable configuration. The sheet of tag holders 10 is then removed from the mold and each tag holder 10 is cut to the desired shape, the tag holders are bundled and the bundles are delivered to the merchandiser customer in the desired amounts.

An example of the thermoforming processes that are available and that may be modified for use with this invention is found in U.S. Pat. No. 5,795,535, the disclosure of which is incorporated by reference herein, where appropriate, and also to the prior art thermoforming processes and equipment described therein. Because the inventive features of the tag holders 10 rely on the specific modifications to the thermoforming process, these will be described in the context of the structure of the display tag holder 10 as described below.

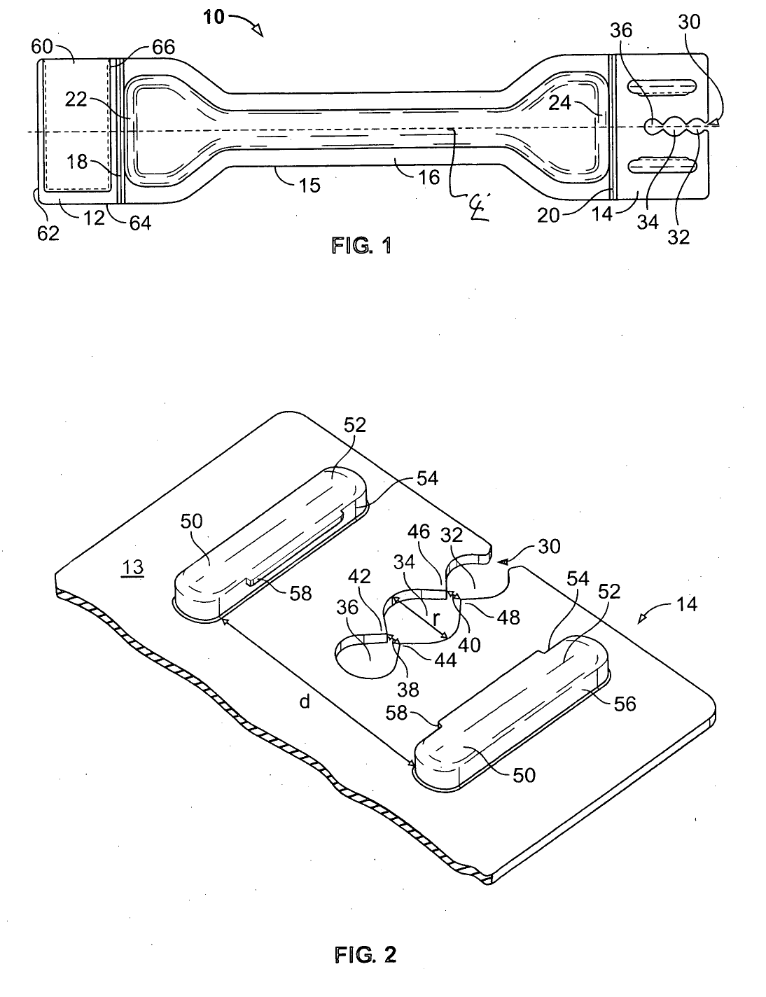

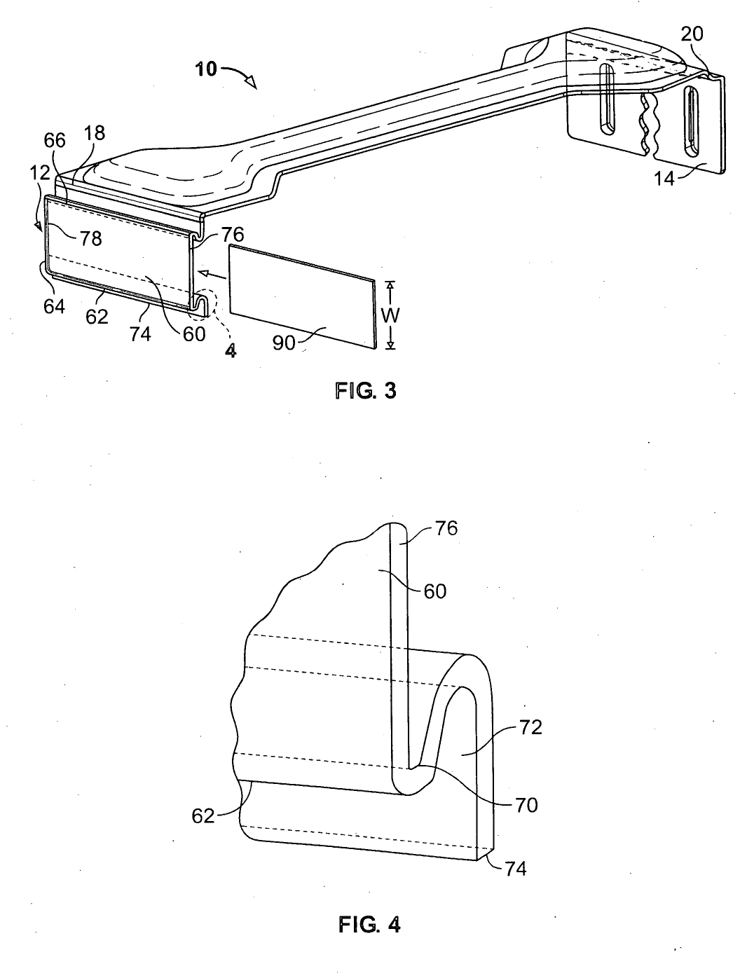

Referring again to FIG. 1-2, the display tag holder 10 includes a display portion 12, a mounting portion 14 and an intermediate portion 16 between the display portion 12 and the mounting portion 14. Fold line 18 separates the display portion 12 from the intermediate portion 16 and fold line 20 separates the intermediate portion 16 and the mounting portion 14. The fold lines 18,20 may be formed by scoring or impressing an indentation in the plastic blank during the thermoforming process in the thermoforming equipment, as taught in the aforementioned U.S. Pat. No. 6,694,654, or by forming an arcuate-shaped, or other similarly shaped, straight and narrow section in the display tag holder 10, which allows for the end portions 12, 14 of the tag holder 10 to be easily bent relative to the intermediate portion 16 and to be deformed along those fold lines 18, 20, thereby to produce the final form of the display tag holder 10 (FIGS. 3, 5 and 6) as used by the customer. Since the intermediate portion 16 is essentially identical to that shown and described in aforementioned U.S. Pat. No. 6,694,654, further description thereof will be limited only to how it relates to the manufacture and use of the inventive display tag holder 10. In any case, the fold lines 18, 20 are immediately adjacent, and directly abut the curved, essentially vertically extending surfaces 22, 24, respectively, as shown.

Referring now to FIGS. 1 and 2, the mounting portion 14 is disposed at one end of the display tag holder 10, and includes a number of features more easily seen in the detail view shown in FIG. 2. The fold line 20, shown in FIG. 1, separates the mounting portion 14 from the remainder of the display tag holder 10. After the shape of the display tag holder is roughed out on the thermoforming platen (not shown), a central inlet 30, in the shape of an elongated cut, together with the final shape of the edges 15 of the tag holder 10 formed by trimming in the trimming equipment. The inlet 30 includes at least one, and preferably three, essentially circular shaped apertures 32, 34, 36, defined by two constrictions 38, 40, that are disposed in the inlet 30 between adjacent apertures, respectively. The restrictions 38,40 are each defined by two corners 42,44 and 46,48 that extend inwardly into the inlet 30, so that they follow a predetermined pattern to match the mounting on a pin or merchandise display hook 80 as discussed with regard to FIGS. 5, 6. Preferably the dimensions of the constriction are about one-half the size of the largest diameter of the apertures 32, 34, 36, but these dimensions may be varied depending on the dimensions of mounting system, the thickness of the plastic film comprising the tag holder 10 and the amount of use that may be expected for each tag holder 10 before it is retired.

Referring now mostly to FIG. 2, the tag holder mounting portion 14 includes two retention protrusions 50 that protrude from the essentially flat surface 13 of the mounting portion 14 for a height of about ⅛ inch, and may have rounded tops 52, inner walls 54 and outer walls 56, as shown. The retention protrusion inner walls 52 and outer walls are preferably parallel to each other and extend in a longitudinal direction parallel to the longitudinal extension of the tag holder 10, as indicated by the center line CL, for a distance that is sufficient to maintain the orientation of the mounting portion 14 relative to the mount, as will be described below. Inner walls 52 face each other and are preferably separated by a predetermined distance d in a direction transverse to the direction in which the walls 54 extend and the centerline CL.

Adjacent the tops 52 of each of the protrusions 50, there is disposed a slightly cantilevered bulge 58 that extends toward the opposing wall 52 of the other protrusion 50. Bulges 58 are shown in a preferable condition to be almost as long as the protrusions, but that configuration is subject to alteration as needed to maintain an interference fit between the mounting portion 14 and the mount of the hook. The longitudinal dimension of bulges 58 may be shorter or longer than that shown, but bulges 58 should be of a sufficient dimension to achieve the retention function, as will be described below. Ideally the bulges are much less wide than they are long, as shown most clearly in FIG. 2.

Referring now to FIGS. 1 and 3-4, the display portion 12 is shown having a front surface 60 and a main rear surface 62, which is particularly adapted to mount and display labels or price tags. However, the preferred embodiments shown and described are not meant to limit the shape or configuration of the inventive display portion as any number of previously known label mounting structures and methods may be used to affix a label to the display portion 12. For example, the inventive mounting portion 14 described above may be used with a tag display portion such as that shown and described in aforementioned commonly owned U.S. Pat. No. 6,694,654. Conversely, and depending on the mounting structure used, the inventive display portion 12 described below may be used with any number of mounting structures, as is appropriate for the arrangement of mounting a hook on any appropriate pegboard wall or wire structure.

The front surface 60 is essentially in a flat plane, as shown, and is bounded at three sides by folded over edges 62, 64, 66, the structure of which is provided by the thermoforming process. As shown most clearly in the detail of FIG. 4, where a side edge is shown as a result of the trimming of that edge 74 in the trimming equipment, the fold produces an S-shaped curve and internal grooves 70 that accommodate insertion of the display or price tag 90 in the direction of the arrow, as shown. The price or display tags are usually standardized and are provided in the shape of a rectangular card having some stiffness, and preferably have approximate dimensions of 1 inch by 2 inches. Card 90 should be sufficiently stiff to hold its shape while being inserted into the internal grooves 70, and also after the passage of some period of time.

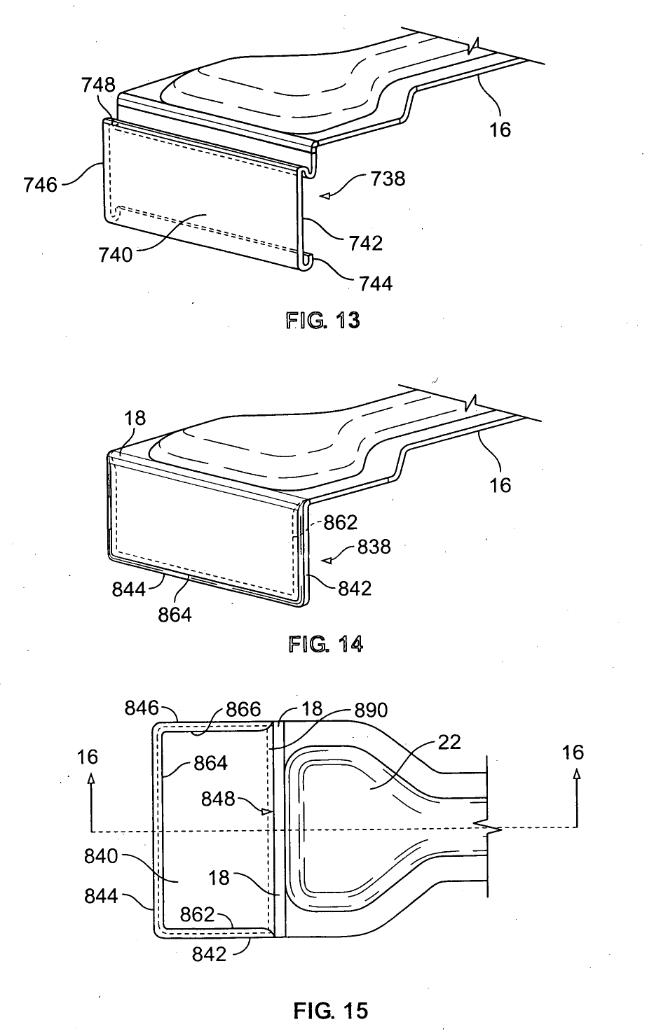

The S-shaped curve of the folded over edges 62, 64, 66 includes a second curve 70 that reverses the direction in which the plastic film extends again in the direction of the cantilevered surface 72 is parallel to that of the display surface 60. Although not essential to the practice of this invention, as will be described with respect to alternative embodiment shown in FIG. 13, preferably the cantilevered surface 72 extends away from the plane of the display surface 60 well beyond the edge 62 to permit trimming of the cantilevered end 74 in the trimming process, at the same time tat the edge 76 is trimmed.

Ideally, the distance between the edges 62 and 68, or more precisely, between the grooves 70 associated with those edges, has a dimension that is identical to or very slightly larger than, the width W of card 90. Thus, the trimmed “cross-sectional” edge 76 provides a smooth insertion vehicle of the card into the display tag holder. As shown in FIG. 3, the transversely extending edge 64, parallel to the edge 76, includes a curved terminal stop forming a groove 78 along its inner surface that is adapted to receive the leading edge of card 90. Continued sliding of the card 90 into the grooves 70 of edges 62, 66 until the groove 78 is reached, provides a secure, but releasable, attachment for the display tag card 90, thereby to enable the display portion 12 to securely hold the leading edge and two transverse edges of card 90 within the grooves 70, 78.

Referring now to FIGS. 5 and 6, the mounting or connection of a merchandise display hook 80 to a display rack is shown. The display rack may be a wire mesh structure 120, as shown, and may comprise interconnected wires or horizontally extending metal rods 122, that are held in place in a grid structure by vertically extending metal rods 124 that are attached, for example by a welded connection, to the rods 122. Other connections are possible, and are intended to be encompassed by the invention. For example, the connection may include a structure for connection to a pegboard, similar to that of the aforementioned commonly owned U.S. Pat. No. 6,694,654. Alternatively, the wall may take other configurations, (not shown) which may include special connections of the mounting portion of the hook 80 to customized display surfaces (not shown, but the invention is most suited for use with standardized walls of displays.

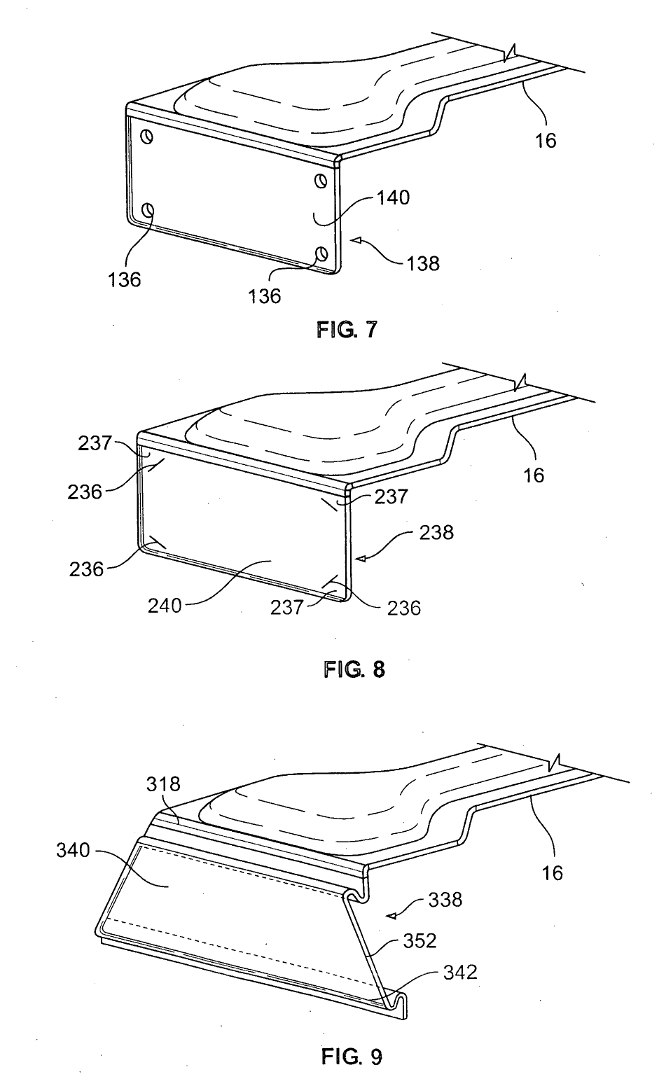

Just prior to use, the holder 10 is arranged for mounting. The mounting portion 14 is bent downwards at the fold line 15, the fold line 15 connecting the mounting portion 14 to the intermediate portion 16, and similarly the display portion 18 is bent downwards at the fold line 17, the fold line 17 connecting the intermediate portion 16 and the display portion 18. In this position both the mounting portion 14 and display portion 18 are deformed to deflect downwardly and are orientated each to produce approximately a right angle relative to the intermediate portion 16. The portions are shown in the bent state during use in FIGS. 4 and 5 for tag holder 10 and in FIGS. 6 and 7 for tag holder 110.

The mounting portion 14 includes a display face 30 and a back surface 32. The mounting portion is shown in greater detail in FIG. 3, and is applicable to either of the two tag holder embodiments 10, 110. As shown in FIGS. 4 and 5, the tag holder 10 is in the assembled position, with the intermediate portion 16 being perpendicularly folded relative to the plane of the face 30. Two apertures 34 are provided in the mounting portion 14.

Additional embodiments are shown in FIGS. 7-16, where the mounting portion may be identical to the ones shown above, or may have a structure similar to the one shown in aforementioned commonly owned U.S. Pat. No. 6,694,654, or may include any other appropriate mounting portion. Thus, the embodiments shown in FIGS. 7-16 only show portions of the front of the display tag holders, which include the display portions 118, 138, 238, 338, 438, 538, 638, 738 and 838.

Referring now to FIG. 7, a display portion 138 is illustrated with the intermediate portion 16 being otherwise identical to that shown in the previous FIGS. 1,3, and 5. One difference in the display portion 138 is that the display tag (not shown) is mounted on the outer surface or the surface facing the consumer when the display tag holder is mounted on the merchandise display. The display tag is mounted onto four apertures that are disposed adjacent the corners of the display surface 140. These apertures may be scored into the surface or cut as apertures into the plastic at the trimming step. The display tag may then be inserted at its four corners, with each aperture holding one corner so that the tag can be positioned and secured to the display tag front surface 140 to be visible to the user.

The embodiment 238 shown in FIG. 8 similarly includes the tag display portion 238 in a flat or planar surface 240 having four slits 236 adjacent the four corners 237 of the flat surface 240. The slits 236 are each angled relative to the corners 237 so that a square or rectangular tag (not shown) can be inserted at its corners into the slots 236.

Another embodiment of a tag display portion 338 is shown in FIG. 9. The front of tag display portion 338 also has a surface 340, but may have any of the means for retaining the display tag on or adjacent the surface 340 as are described herein. As shown in FIG. 9, the tag display portion 338 includes the groove structure as shown in, for example, FIGS. 1-5, having folded over edges 362, 364, 366 that provide for a groove capable of receiving a display tag, such as that shown in FIG. 3. However, the surface 340 does not have a rectangular outline as in other embodiments herein, but instead has the shape of a trapezoid having two angles sides 350, 352. In effect, the surface of the front display portion for any of the embodiments with the folded over edges, as described herein, can have any quadrilateral shape as long as two of the sides are parallel to each other so as to permit the display tag to be able to slide into the grooves. In the shape shown in the embodiment of FIG. 9, the trapezoid includes three grooved edges 362, 364, 366 for receiving an edge of the display tag. Of course, the display tag preferably has a similar shape as that of the surface 340, so that the full area of surface 340 is covered by the display tag. Alternatively, some part of the area of surface 340 may not be covered by the display tag, so as to produce an ornamental effect.

For those embodiments that have no grooves, for example, front display portions 138, 238 (FIGS. 7 and 8), the shape of the surface 140, 240 can take any shape, as long as it is sufficiently long at the folding edge to be capable of providing a fold line 318, so that the tag display portion 338 can be folded down, as shown. The two parallel folded down edges 342, 346 will hold the display tag in place within the holder so that the tag holder is retained in the tag holder during normal usage in a merchandising retail environment.

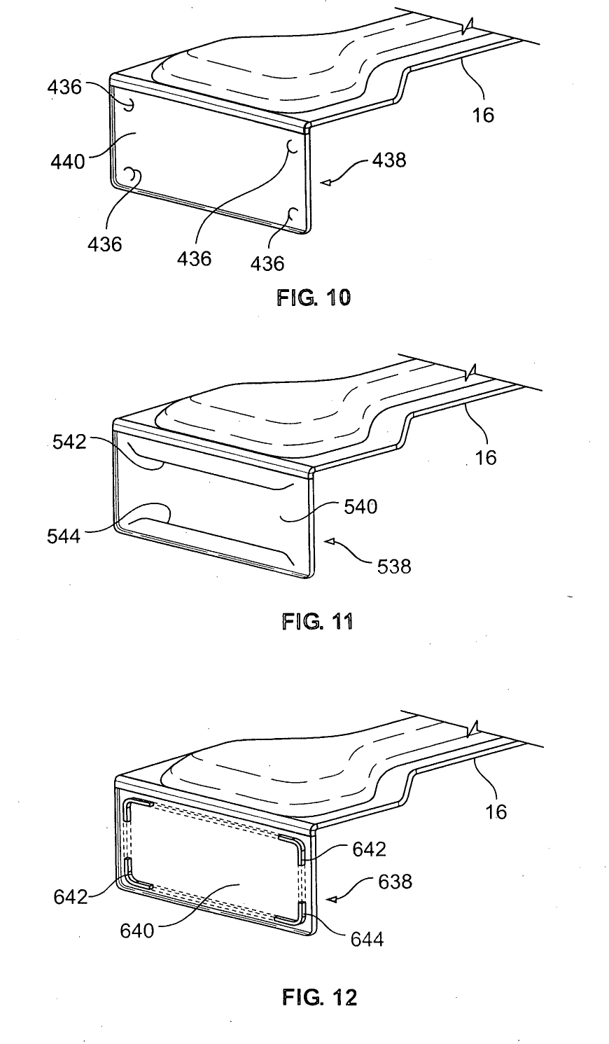

The display tag holder shown in FIG. 10 similarly includes the tag display portion 438 in a flat or planar surface 440 having four slits 436 adjacent the four corners 437 of the flat surface 440. The slits 436 are each similar to the slits 236 shown in the tag display portion 238 of FIG. 8, except that the angled slits are provided as semicircles with the open end facing away from the corners 437 so that a square or rectangular tag (not shown) can be inserted at its corners into the slots 436. The semicircular slits 437 are considered to be able to provide a more flexible aperture in which the corners of a display card may be inserted. While the apertures are shown to be somewhat removed from the corners 437, it may be more advantageous in covering the surface 440 to locate the slits 436 closer to the corners 437 to avoid the strips of clear plastic surface adjacent the edges.

The tag display portion 538 shown in FIG. 11 similarly has cutout apertures, as in the embodiments of FIGS. 8 and 10 of the surface 540 and are in the shape of long slots 544 that extend essentially parallel to the top and bottom edges. The cutout apertures slits 544 are separated by a distance of slightly larger than that of the width of the tag, for example, display tag 90 (FIG. 3). That is, if the width W of the display tag equals one inch, the distance between the parallel slits 544 would be slightly less than one inch to permit the display tag to be inserted in between the slits and the surface so that the display tag is held in place on or behind the surface 540 of the tag display portion 538. A user would only have to insert the tag between the slits 544 to hold it in place.

Another embodiment of the tag display portion 638 is shown in FIG. 12. It also has a flat, that is, a non-folded over surface 640. However, instead of cutout apertures, e.g., 436, 544, it has a series of raised or protruding L-shaped projections 642, 644 that are at a distance from each other that correspond to the width and length of a display tag, such as tag 90 shown in FIG. 3. The projections 642, 644 are spaced in a pattern essentially corresponding to the corners of a display tag. The protruding projections 642, 644 may have overhanging portions under which the display tag can be inserted to be held in place, again either in front or behind the surface 640.

Referring now top FIG. 13, a tag display portion 738 is shown which in most respects is identical to the tag display portion 12 shown in FIGS. 1,3 and 5, except that instead of having three edges with a folded over edge, only two parallel edges are shown, a bottom folded over edge 742 and a top folded over edge 748. The two opposing side edges 742, 746 do not have the grooves for stopping the display tag, as this allows the display tag to be inserted or removed from either edge 742,746.

One other difference in the tag display portion 738 is the folded over edge 744 has only an upturned U-shaped slots for the card to be inserted into. This configuration may also be used with the previously described embodiments shown in FIGS. 1-6 and 9, but the edge 744 may not be preferred because of the difficulty in forming such an edge on a vacuum thermoforming machine.

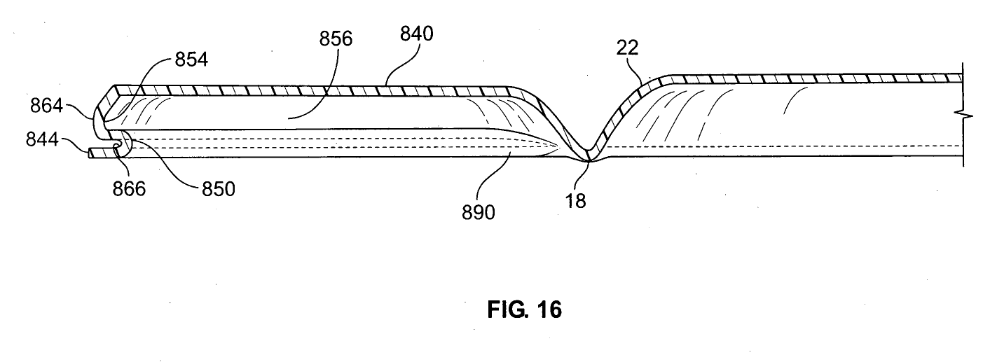

Another embodiment for the display tag holder of the present invention is shown in FIGS. 14-16. The tag display portion 838 is again only shown, as the mounting portion may take any form as discussed above. The tag display portion 838 is in most respects the same as portion 12 shown in FIGS. 1 and 3, however, instead of having an open groove at the side edge 76, as in the embodiment of tag portion 12, the open edge is at the top edge 878, as will be explained. FIG. 15 is a plan view of the tag display portion 838 as shown from the underside, that is, the opposite side than that shown in FIG. 1. FIG. 16 is a cross-sectional view of the tag display portion 838 taken approximately along the line 16-16 of FIG. 15. Each of the views will be described together and separately, as each view shows a different aspect of this embodiment.

The tag display portion 838 also bends at a fold line 18, as in earlier embodiments, but instead of having a folded over edge, such as the folded over edge 66 of the tag display portion 12 shown in FIG. 1, a slot opening 890 provides ingress for insertion of the card into the enclosure provided by the other three edges 842, 844, 846, which each have a folded over edge 862, 864, 866, providing for grooves 852, 854, 856 for receiving the tag, for example, tag display 90 (FIG. 3).

As can be seen from the cross-sectional view of FIG. 16, the grooves 854, 856 are deep enough to be able to receive the display tag 90, and the dimensions between the ends are such that the grooves can accommodate standard display tags. Of course, the dimensions of the grooves, the separation between the grooves, etc., can be changed to accommodate a particular customer's display tags. For example, different dimensions may be necessary for stores located in a metric system state, and some custom made display tag holders may be provided for specific promotional merchandising applications, as required in the industry. Thus, the description is to be considered suggestive of the possible available configurations that will be come readily apparent to a person having ordinary skill, once the concept of the present invention is understood. That is, once there is a grasp of the concept of the invention, the applications to which the thermoformed display tag holder having the folded over edges for receiving a display tag are numerous to elaborate in a patent simple application in which the concept of the invention is described and claimed.

The tag display portion embodiment 838 of FIGS. 14-16 may be considered to be preferred over the other embodiments for a number of reasons. One main one is that the display tag holder having a portion 838 provides a much diminished opportunity for pranks to be sprung on unsuspecting customers at a retail establishment by the interchange of display tags from one item to another. The process of inserting the display tag 90 (FIG. 3) into the side slot is simple enough, but that process is also readily apparent to mischievous persons at a retail establishment who strive to create confusion with the store personnel and customers. Changing the display tags from similar, but differently priced, items would be an invitation to much consternation and need for mollification of customers if the price that was ostensibly indicated as being different than that which comes up at the cash register when the item is rung up.

The top loading insert of the display tag is done when the display tag holder is flat and in the position shown in FIG. 16. That is, the tag is inserted into the slot 890 until it engages all three of the grooves 852, 854, 856, and then the tag display portion 838 is folded about the fold line 18. The folded over tag display portion 838 thus locks the tag into place after it is folded over, and is more difficult for a mischievous person to remove, since the removal process would require the bending up of the display tag portion 838 and removal from the back of the surface 840. More importantly, the lack of a visible means to extract display tag from the display tag potion 838 would not suggest to the passing mischievous person that the tags were in any way removable from the tag holders. Thus, the dual effect of the locked in tag and the hiding of the insertion slot opening 890 minimizes the chance that a person would first think of removing the tags and secondly of finding an easy way to do so.

It will be appreciated by those having skill in the art that there are many varieties of known display hooks and support structures other than a wire mesh 120 (FIG. 5) with which the tag holders 10 may be used. For example, a wall for attaching hooks thereunto, having appropriately spaced slats (not shown) in the form, shape and dimensions to accommodate the hooks 80, may be used. Also, by modifying or altering the construction, such as changing the shape, dimensions and configuration for the holders 10, while still practicing the form of display portion according to the present invention at the opposite, distal end of the hook 60, it may be possible to provide different configurations to include other types of hooks and mounting structures.

The present invention has been described with reference to the preferred embodiments. However, the scope of the present invention is intended to include many modifications, alterations or equivalents. For example, the length of the intermediate portion 16 has been shown to be of a specified dimension, but persons having experience in the field will understand that both the length and the relative width of the intermediate portions may be modified to accommodate different size hooks. Thus, the scope of the invention is not to be considered limited by the described embodiments but is limited only by the following claims and their equivalents.

What is claimed is:

1. A thermoformed display tag holder mounted in association with a hanging merchandise display hook extending forwardly from a vertical display surface, the merchandise display hook including a forward hook portion and a mounting portion, the display tag holder comprising:
a) a holder mounting portion at a distal end of the display tag holder for attaching the display tag holder to the mounting portion of the hook at a position adjacent the vertical display surface;
b) a tag display portion disposed along a longitudinal centerline of the display tag holder at a proximate, opposite end from said holder mounting portion, the tag display portion including a front display surface and an integral means for retaining a display tag; and
c) a longitudinal intermediate portion extending between said display and said mounting portions,
wherein the integral means for retaining a display tag includes at least two opposing edges that are parallel to each other and that each define at least one integral inwardly facing retention member separated by a predetermined distance from the opposed retention member associated with the other parallel edge, the predetermined distance between each of the two retention members being capable of retaining at least two parallel edges of the display tag.

2. The display tag holder of claim 1, wherein two oppositely disposed retention members further comprise integral protruding overhanging ridges each defining a groove facing inwardly toward the center of the display surface, the grooves being separated by the predetermined distance, the predetermined distance being calculated to slidably receive and retain between the grooves two parallel opposed edges of the display tag.

3. The display tag holder of claim 2, wherein a third retention member extends along an edge not parallel to the two oppositely disposed retention members and further comprises an integral protruding overhanging ridges each defining a third groove facing inwardly toward the center of the display surface, the third groove being arranged to receive an other edge of a flat display tag, the other edge being at an angle relative to the two parallel edges that essentially matches the angle of the third retention member to the to slidably receive the other edge into a groove formed by the ridge of the third edge.

4. The display tag holder of claim 1, wherein the display tag holder further defines a longitudinal centerline extending between the oppositely disposed tag display portion and the mounting portion, and a fold line between the intermediate portion and the tag display portion and a fold line between the intermediate portion and the mounting portion, each of he fold lines being essentially perpendicular to the centerline, and each fold line permitting the respective portion to be folded out of a plane generally defined by the tag holder.

5. The display tag holder of claim 1, wherein two oppositely disposed retention members further comprise cuts at each corner of the front display surface, each cut being positioned and oriented to receive one corner of a flat display tag.

6. The display tag holder of claim 4, wherein the cuts at each corner of the front display surface further comprise diagonal slits adjacent each corner.

7. The display tag holder of claim 4, wherein the cuts at each corner of the front display surface further comprise semicircular slits adjacent each corner.

8. The display tag holder of claim 4, wherein the cuts at each corner of the front display surface further comprise semicircular slits adjacent each corner.

9. The display tag holder of claim 4, wherein the cuts at each corner of the front display surface further comprise semicircular slits adjacent each corner.

10. A thermoformed display tag holder mounted in association with a merchandise display hook extending forwardly from a mounting surface, the merchandise display hook including a hook portion and a mounting portion, the display tag holder comprising:
a holder mounting portion at one end of the display tag holder for attaching the display tag holder to the hook mounting portion adjacent the surface;
a tag display portion disposed along a longitudinal line of the display tag holder at an opposite end from said holder mounting portion, including integral projections providing for retention of a display tag; and
a longitudinal intermediate portion extending between said display and mounting portions.

11. The display tag holder of claim 10, wherein said mounting portion further comprises a central inlet extending longitudinally in a direction along the centerline of the display tag holder, the central inlet including two restrictions spaced longitudinally along the central inlet, said restrictions being spaced and configured to define essentially semicircular apertures two of which, when opposed on the opposite side of the centerline of the inlet, define an open area for receiving a plurality of hook attachments that attach said merchandise display hook to a hook mount.

12. The display tag holder of claim 11, wherein the two semicircular apertures disposed on opposite sides of the central inlet are shaped and configured in the form of an essentially circular aperture that can surround a hook attachment to its mount.

13. The display tag holder of claim 12, wherein two oppositely disposed integral projections further comprise integral protruding overhanging ridges each defining a groove facing inwardly toward the center of the display surface, the grooves being separated by the predetermined distance, the predetermined distance being calculated to slidably receive and retain between the grooves two parallel opposed edges of the display tag.

14. The display tag holder of claim 10, wherein two oppositely disposed integral projections further comprise integral protruding overhanging ridges each defining a groove facing inwardly toward the center of the display surface, the grooves being separated by the predetermined distance, the predetermined distance being calculated to slidably receive and retain between the grooves two parallel opposed edges of the display tag.

15. A method of manufacturing a display tag holder mounted in association with a hanging merchandise display hook extending forwardly from a vertical display surface, the merchandise display hook including a forward hook portion and a mounting portion, the display tag holder comprising:
a) providing a plastic blank.
b) thermoforming a holder mounting portion including a first fold line at a distal end of the display tag holder for defining an attachment portion to attach the display tag holder to the mounting portion of a merchandise hook and a second fold line defining a display portion at a proximal end of the display tag holder and an intermediate portion between said fold lines; and
c) trimming said plastic thermoformed blank to obtain a merchandise display tag holder having two ends foldable relative to the intermediate portion.

16. The method of manufacturing a display tag holder according to claim 15 wherein trimming further comprises cutting the lateral edges of the display tag holder by using a cutting tool for providing border area around the lateral edges of the display tag holder.

17. The method of manufacturing a display tag holder according to claim 15 wherein thermoforming of the display tag portion further includes thermoforming a at least two opposing sides that are parallel and cantilevered over a display surface to define two parallel grooves shaped and configured to retain a display tag.
